(19) United States
(12) Patent Application Publication
(10) Pub. No.: US 2016/0009415 A1
(43) Pub. Date: Jan. 14, 2016

(54) EXPANDED AIRLINER CONFIGURED SYMMETRICALLY REAR TO FRONT OR REAR TO REAR

(71) Applicant: Brian Lee Uitdenbogerd, Las Vegas, NV (US)

(72) Inventor: Brian Lee Uitdenbogerd, Las Vegas, NV (US)

(21) Appl. No.: 14/173,165

(22) Filed: Feb. 5, 2014

(51) Int. Cl. B64F 5/00; B64C 1/26; B64C 1/00

(52) U.S. Cl. CPC B64F 5/0009; B64C 1/00; B64C 1/26

(57) ABSTRACT

Currently the world's largest airplane is Airbus A380, can carry 525 people in a normal three-class configuration. It can travel nonstop 15,700 kilometers (8,500 nmi; 9,800 mi), at a speed of Mach 0.85 (about 900 Km/h or 560 mph; 490 kn at cursing altitude). To carry twice as many passengers and fly the same distance with the similar performance or better can achieved by joining the two same types of airplanes in the rear to front, (FIG. 1), or rear to rear (FIG. 2), can have the equivalent or better effect, and have similar or better performance than keep on building larger, fatter, airplanes such as A380. For example, Airbus, A350 can carry 350 passengers in a three-class setting, if the two A350s are jointed, it can carry, 700 passengers instead of only 350. This will work on other makers with the two same types of large airplanes.

### BACKGROUND OF THE INVENTION

Why build larger airliner that are double decked, bigger and fatter when we can have the same benefits as by making it longer by joining the two same types of airliners rear to head or rear to rear of the body, fuselage of the airliners.

### BRIEF SUMMARY OF THE INVENTION

### Technical Problem

Can an airliner be built using two same types of airliners to make it an one airliner with one single fuselage to haul more passengers and cargo than a existing single airliners that are operating in the airports and in the skies around the world.

### Technical Solution

By utilizing the two same-type of airliner and joining the airliners symmetrically, rear to front or rear to rear of the airliners is most effective and economical to build. Once it is joined the configuration is changed to meet the standards of Federal Aviation Administration, FAA, and other Aviation Administration of the world to make the airliners airworthiness that can fly safer and as the current airliners operating around the world today. All airliners two of the same types, even Airbus A380 or even Boeing 747-8 can be symmetrically jointed rear to front or rear to rear to make the truly the worlds largest airliner in the world with the current available technology we have without having to make the airplanes fatter in the body, fuselage, of the airliners and spend lot of money and time on the research and development to see if the new shape will work. Why not use the two shapes that all ready works and combine it into one.

### Advantageous Effects of Invention

Symmetrically combining the two same type airliner that have proven to be safe to make it so it can haul almost the twice as many people and cargo at one given time. More seats on a single flight can mean cheaper tickets. The airliner will land on four sets of landing gear rather than three will give more stability on take offs and landings. Also, it eliminates front landing gear, it means less cost to make and maintain. See FIG. 5 and FIG. 6, they have not front landing gears. Building symmetrically can also reduce the production cost and time as building a large airliner, that are fatter in the body, fuselage, of the airplanes. Not to mention the investment in the billions of dollars in making the new facilities to build these double decked airliners similar to Airbus A380. Why go larger and fatter on the fuselage when you can build it longer by combining the two same types of existing airliners hauls more people and this reduces the air traffic in the skies. No need to change the current airport facilities to meet the requirements to accommodate the new bigger, taller, fatter fuselage airliners. To show how the symmetric airliners would look, an Airbus A350 airplane model in the scale of 1:144 is shown in the Figures filed herewith.

### BRIEF DESCRIPTION OF DRAWINGS

FIG. 1 is a side view of the two same-type A350 model airplanes, airliners jointed rear of airliner to the front part of the airliner would look like.

FIG. 2 is a side view of the two same-type A350 model airplanes, airliners jointed rear of airliner to the rear part of the airliner would look like.

FIG. 3 is a top view of an airliner parts and functions.

FIG. 4 is a side view of the two same-type A350 model airplanes, airliner jointed rear of airliner to the front part of the airliner with modifications to look as the current airliners except it has the two sets of large main wings instead of one.

FIG. 5 is a side view of the two same-type A350 model airplanes, airliner jointed rear to rear with modifications to make it a perfect symmetric airliner with two sets of wings instead of one.

FIG. 6 is a side view of the two same-type A350 model airplanes, airliner jointed rear to rear with modifications to make it a perfect symmetric airliner with two sets of wings are jointed together to give it more stability and strength.

FIG. 7 is a side view of the two same-type A350 model airplanes, airliner jointed rear to rear with modification and have all four engines facing the direction of the travel of the airliner.

FIG. 8 is a top view of the two same-type A350 model airplanes, airliner jointed rear to rear with modifications.

FIG. 9 is a front view of the two same-type A 350 model airplanes, airliner jointed rear to rear with modifications, the other end would have the same configurations because they are symmetrical.

FIG. 10 is a top view of the two same-type A350 model airplanes, airliner jointed rear to rear with modification but with all four engines facing the direction of the travel of the airliner.

### DETAILED DESCRIPTION OF EMBODIMENTS

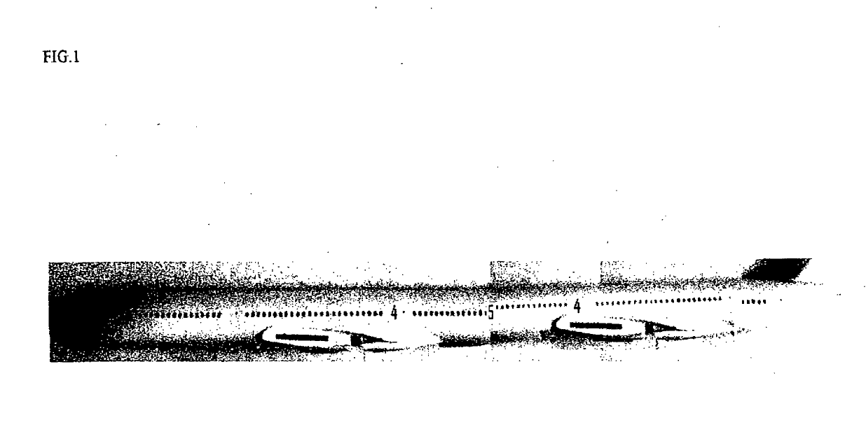

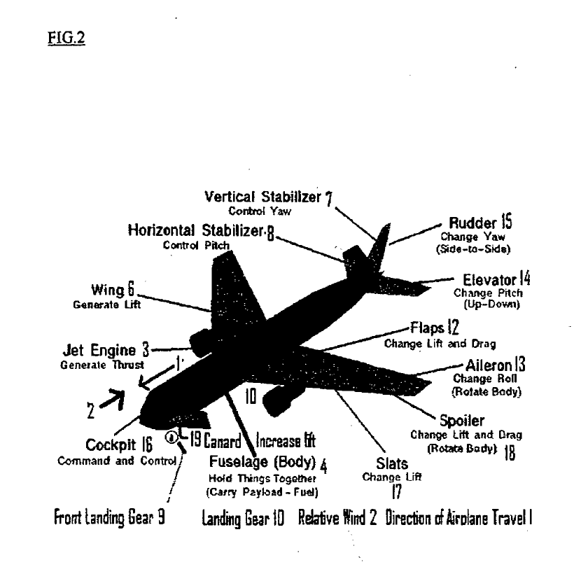

Now, the preferred embodiments of the present invention will be described in detail with reference to the drawings. These pictures taken from A350 model airplane in the scale of 1:144 to show that the real life size airliners would like made with the same design, two life size same-type of airliner jointed symmetrically rear to front, FIG. 1, or rear to rear, FIG. 2, and doing some modifications required to make the airliner balanced, safe, efficient, effective and airworthy to fly and meet all the standards of the Federal Aviation Administration or any other Aviation administrations requirements in other parts of the world.

FIG. 1 and FIG. 2, A side view of the two same-type of airliners joined would look, airliners jointed rear of the airliner to the front part of the airliner would look like. The 4s are the fuselage of the A350 and 5 is the where the two airliners are jointed rear to front of the airliner. 5 is also area of CG, center of gravity, even after all the other modifications made to the airliner on both sides the CG will stay around the same point.

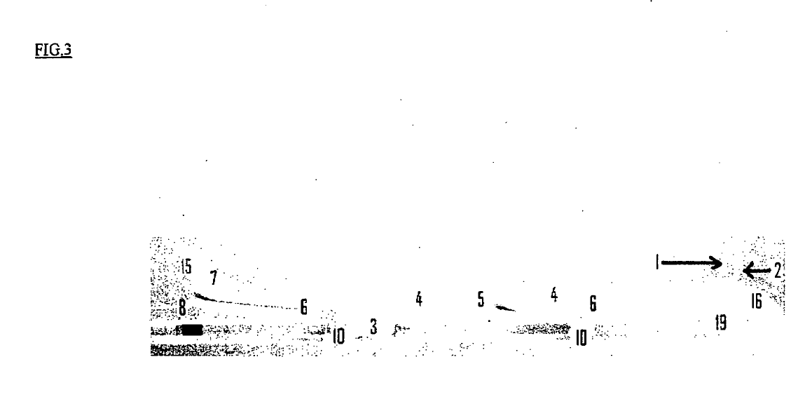

FIG. 3, is the diagram of the parts of the airliners and how they function are all the same on the airplanes and airliners. The new symmetric airliners will be no different. It has all the parts the same as a single body airliner and its functions of the parts are the still the same.

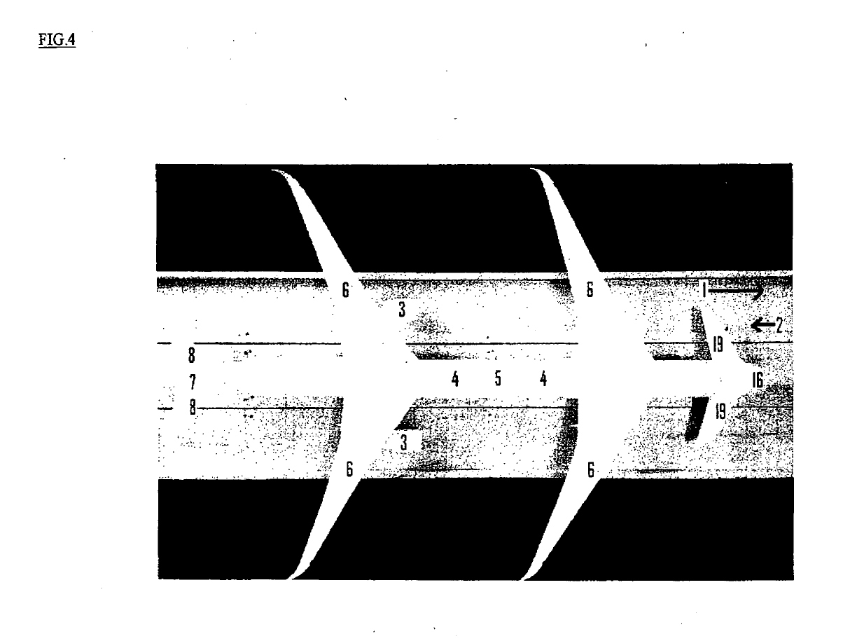

FIG. 4, A side view of the two same-type A350 model airplanes, airliners jointed rear of the airliner to the front part of the airliner would look like. When combining two same types of airliners to one will require the engineers to do modifications required to make the airliner to meet the standards to fly it safe. The numbers 4 are the fuselage of the A350 and 5 is the where the two airliners are jointed rear to front of the airliner. 5 is also the CG, center of gravity where the right side of the airliner will be equal to the left side of the airliner. The two sides will be balanced, equal in weight, horizontally and laterally. When joining the two same-type of the airliner all the parts and its functions are still the same. Cockpit 16, is the command and control, front landing gear 9 is optional, rear landing gear 10 will be changed to center landing gears and they will be four instead of two, fuselage (body) 4 is two of the same-type of airliner joined as one body, 5 is where the two fuselage is joined. Jet engines 3 are four of them instead of two. Although it has four it does not need to operate all four at one time. It can operate 2 at a time but need to a have bigger engines to accommodate the increase in the weight of the airliner. Also the engines may be aligned one right behind the other or off set it t like the engines that look like the Airbus A380 or Boeing 747s. If aligned right behind each other, it may help be able to burn the exhaust again from the front set of the engines that did not burn all of it the first time. On the other hand this exhaust, black smoke and other particles and heat from the front set of the engines can damage the rear set of the engines. The wings 6 will have four instead of two, on the wing the slats, spoilers, aileron 13; flaps 12 will be on each of the wings to perform its functions. Not whole lot of changes required on the wings 6. Horizontal stabilizers 8 maybe larger to accommodate the length, more weight in the front, and 14 elevators will be also larger to control the up and down movement of the front of the airliner. The vertical stabilizer 7 will also be larger and the rudder 15 will also be larger too to change the yaw, side to side movement of the longer airliner than the original one. The advantages of this configuration are that the airliner will look the same as those airliners operating around the globe today. The difference would be four wings generating lift instead of two, fuselage is twice as long and no front landing gear, and with the four landing gear around the center of gravity will offer more stability during the landings and take offs.

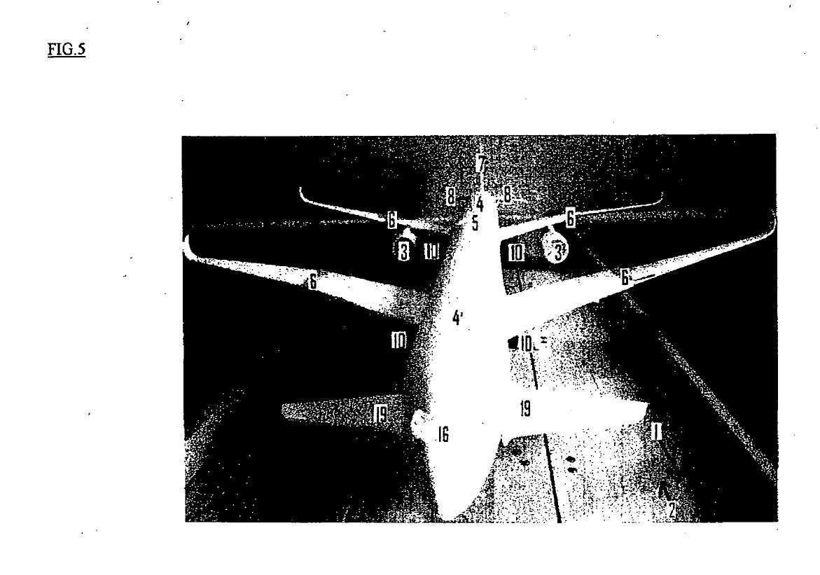

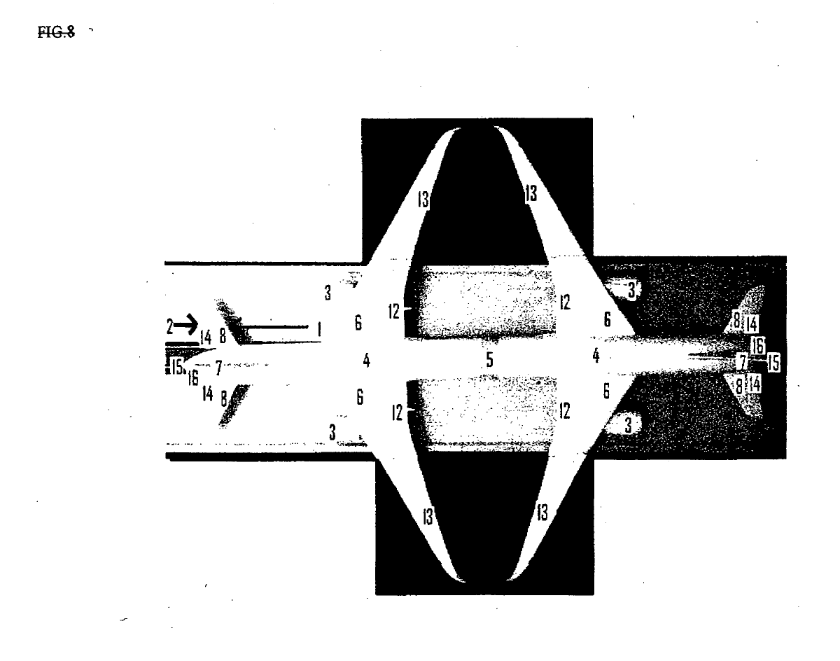

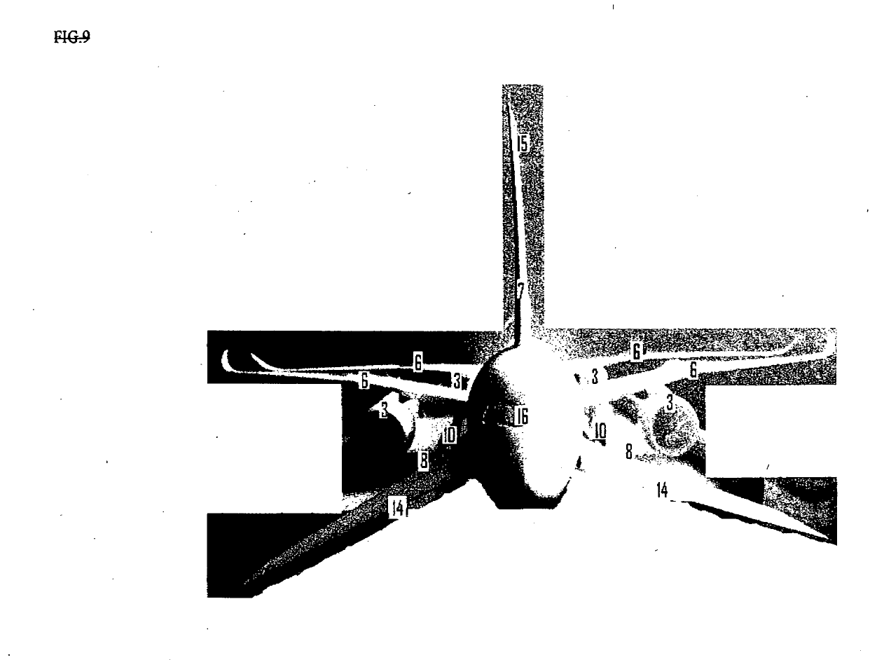

FIG. 5 is shows how it would look when a two airliners are joined rear to rear. In this the cockpit 16 will be two one on both ends. The vertical stabilizer 7 would need to be mounted on roof on the each end behind the cockpit 16 area. The rudder 15 on the vertical stabilizer 7 would work one at a time. The rear of the direction of the movement 1 rudder will work. Or, have both rudder 15 to work together to assist in more smoothly changing the yaw by the rudder 15 moving in the opposite directions to give it a more coordinated turn. If one rudder 15 is used in turning all the time, than a bigger size of vertical stabilizer 7 and rudder 15 to compensate the weight and resisting force to over come sufficiently. The horizontal stabilizer 8 and elevator 14 configured on the front part of the airliner behind the 16 cockpit in the middle part of the fuselage 4 as shown on the FIG. 5 This too, they can work in conjunction or have them work separately. If they are working separately, than the appropriate sizes need to be installed to over come the resisting forces to raise or lower the front of the airliner in the direction the of the airliner movement 1. Front landing gear 1 can be optional, have or don't have. Four rear landing gear 10 in the center near the CG would give it more than enough to give it a stability during the take offs and landings. FIG. 8 is the top view of the rear to rear joining of the two same type of the airliner and as you can see it is perfectly symmetrical. FIG. 9 is the front view of the two same type of airliner joined. The front Horizontal stabilizers 8, elevators 14, vertical stabilizer 7 rudder 15, and cockpit will have the exactly the same ones in the back. The engines are indicated as 3 have four instead of 2 on a normal airliner. If the engines are facing the same way as it is shown on FIG. 5, the engines pointed in the opposite direction, engines in the opposite of the direction of the movement 1 can be used to pull out from the parking ramp area without the assistance from the airplane pusher vehicles.

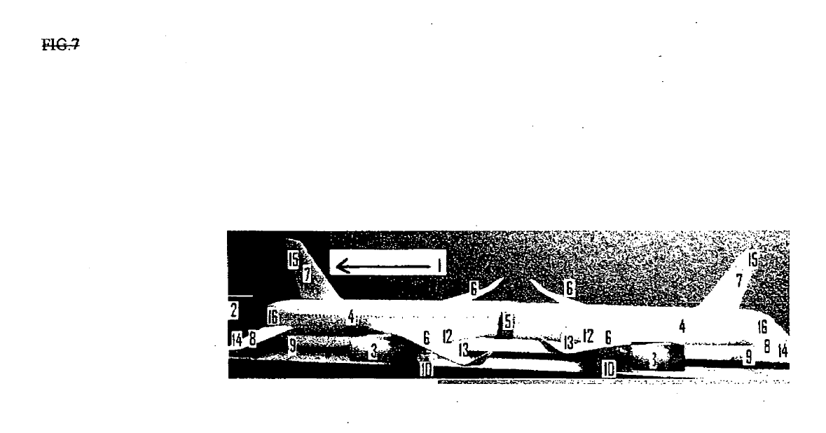

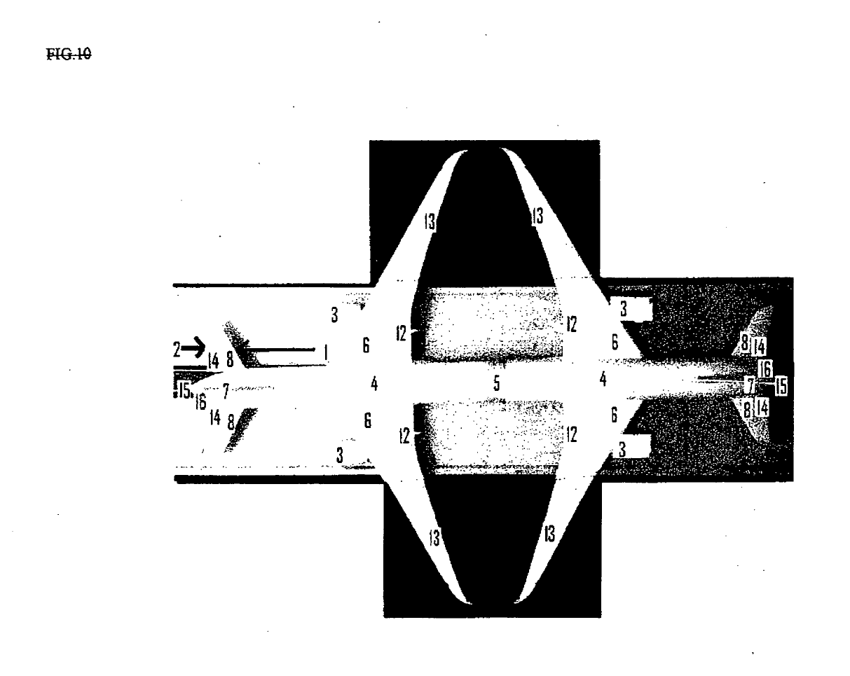

The engines can burn two at a time, for example use the two facing the direction of the movement 1 the airliner or have the engines to have a 180 degree rotation mechanism to face all the same way in the direction of the movement 1 as shown on the FIG. 7. All four engines would have this rotational mechanisms would allow the flexibility for the pilots to maneuver more effectively on the ground when they are taxing. Also incase of an emergency where the brakes fail and pilots can use the engines to bring the airplanes to stop or slow it down. FIG. 10 shows the top view of how it would look with all four engines facing the same direction of the movement 1.

On the wings 6 may require some modifications on the flaps 12. On a normal flaps on a airliner, when the flaps are extended it gives a great curvature to create more lift and drag. However on a symmetrical airliner it need to be shaped less curvature, more of straight, wing flaps extended it will just give a more of straight or little up flow to less interfere with the airflow flowing to the behind its wings. In fact it needs to be engineered to work together to give it more left with the reduced drag. Also the aileron 13s can work one set of time or to have working all four working together to give it more smooth turn.

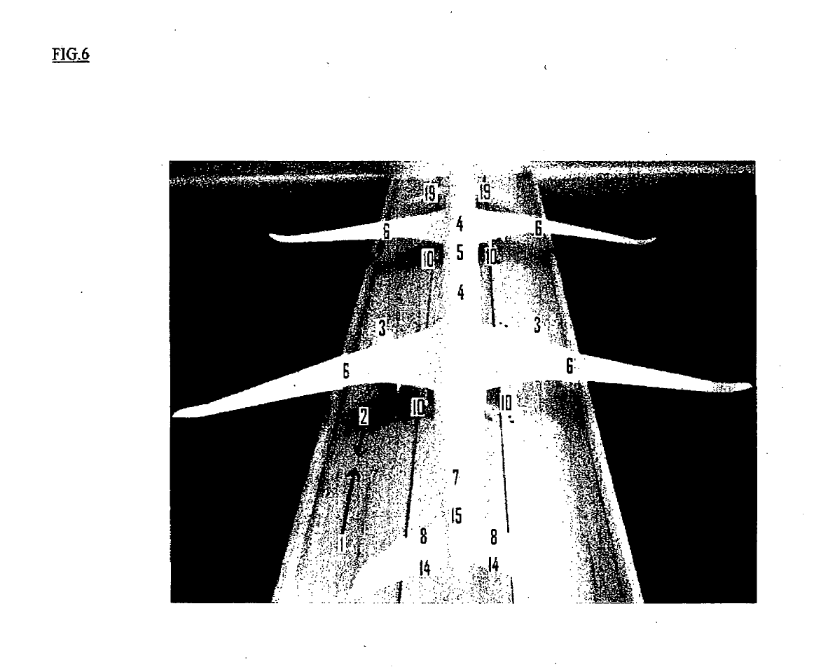

As shown on FIG. 6. Possibly the wings 6 would be joined together, where it is show on FIG. 6, 11, this would give it a more strength and stability to the airliner. This kind of modification it maybe gives wings to generate more lift, and strength to fly higher makes it more efficient for the engines to work more efficiently. The design of the wings allow for a higher service ceiling. A jet engine is more efficient at higher altitude, in other words the wings are all jointed to each other this will allow the plane to fly at higher altitudes, and the fuel flow the engine consumes will lower as result the better gas mileage.

Symmetric airliners give a back up, a double of every thing. Cockpits 16 can be on both ends. So if one fails, one can use the other one. For safety the airliners have many redundant back up systems and symmetric airliners would add more safety futures added to the redundancy to give it more added safety features and back ups.

This invention can applied to the aviation industry in improving the current airliners to carry more passengers and cargo safely, with efficiency. This would give a new meaning to the airliners on how they look and perform in the future. This can reduce the operating cost to operating an airliner but also less traffic around the airports and in the sky.

What is claimed is:

1. Two in one. Two airliners joined together to one airliner. It pears to be one long airliner but it is not. It is two separate airliner joined rear to front to have one cockpit. Two in one but all the parts and functions will work as one airliner. No changes in the production of the airliners except for the last part where the two airliners are joined. All the parts and functions are to work together as one. Except for the Tail end may need a larger vertical and horizontal stabilizers to better control the longer weight and load in the front. As indicated in FIG. 1. Airliners are extended almost the twice of its length. By joining two same type of airliners rear to the front to make its appearance to look like one long airliner but it is two airliners joined rear to front to work together as one airliner, FIG. 1, 4. FIG. 1, 5 is where it is joined and it would be the center of gravity, make this point a point of perfect balance and strongest part of the fuselages of the aircraft. The two fuselages will be attached using a newly designed large bulkhead frame and skin splice at each intersection.

2. As indicated in FIG. 3. Airliners are extended almost the twice of its length. Essentially it is like joining two same airliners, one the tail portion removed the other one the cockpit portion removed and joined to together into a one long airliner, FIG. 3, 4 FIG. 3, 5 is where it is joined and it would be the center of gravity, make this point a point of perfect balance.

3. Two airliners are symmetrical and the way it is joined is tail portion is removed and the other airliner the cockpit is removed. The two are joined rear part of airliner to the front part of the airliner. Two airliners joined but the controls and the functions are all the same as a single airliner as indicated in the legends of the functions & controls on FIG. 2 are all the same regardless of one airliner or a two airliners joined back to front. Furthermore the placement of the wings, vertical and horizontal stabilizers the placement location does not change except for the size maybe larger to leverage the increased length and load in the front of the airliner.

4. The fuselage length is equal in weights over the center of gravity. There are four wings, two wings on each set of airliner creating lift. All wings the size and shape are the same.

5. The two engines are in the rear of the two wings, one on each wing to reduce the turbulence to maximum level. The engines will be strong enough to power using only one engine incase if one of the engine quits.

6. The center of gravity, where the two airliners are joined, need to be reinforced to endure even the any irregularity in lift. As the equal lifts is generating from all the wings the stress will not be a big factor still reinforcement will erase any safety issues. The attachment of the two fuselages will be newly designed large bulkhead frame and skin splice at each intersection.

7. The landing gears are four sets, two sets on each body as it is under the each main wing. The landing rear will need to be longer to help clear the rear tail portion of the airliner during the take off and landings. The strengthen the landing gears maybe required to take on greater loads from the eliminated front landing gears from the both airliners that were joined. The one landing gear from each airliner can reduce in the production cost.

8. The jet engines are mounted in the rear wings, one on each. The engines are mounted on the same location on its wings as it is manufactured for a single airliner. Each engine will be more than enough power to operate as one engine incase one engine do malfunction.

9. The overall the cost to make this symmetrical airline can be a cost saving in production cost and operating cost over building a large double deck airliners.
